(19) United States
(12) Patent Application Publication
(10) Pub. No.: US 2026/0070032 A1
(43) Pub. Date: Mar. 12, 2026

(54) SYSTEMS AND PROCESSES FOR RESIDENCE TIME CONTROL IN DOWNER REACTORS

(71) Applicants: T.EN Process Technology, Inc., Houston (TX); SAUDI ARABIAN OIL COMPANY, Dhahran (SA)

(72) Inventors: Eusebius GBORDZOE, Houston, TX (US); Kenneth KRUG, Houston, TX (US); Mashari ANANZI, Dhahran (SA); Abdennour BOURANE, Dhahran (SA)

(21) Appl. No.: 19/107,338

(22) PCT Filed: Aug. 31, 2023
(86) PCT No.: PCT/US2023/031694

§ 371 Date: Feb. 27, 2025

Related U.S. Application Data
(60) Provisional application No. 63/374,239, filed on Aug. 31, 2022.

(51) Int. Cl. B01J 8/00; B01J 8/24; C10G 11/18

(52) U.S. Cl. CPC B01J 8/003; B01J 8/0055; B01J 8/24; C10G 11/18; B01J 2208/00752; B01J 2208/00938; B01J 2208/00991

(57) ABSTRACT

A downer reactor assembly includes an outer disengager vessel, at least one downer reactor extending vertically from a top end to a lower end within the outer disengager vessel, and a mushroom-shaped distributor end cap positioned at the lower end of the at least one downer reactor. A process for cracking a hydrocarbon feedstock includes providing a catalyst feed to at least one downer reactor assembly. Discharging the catalyst feed at a lower end of at least one downer reactor underneath a mushroom-shaped distributor cap. The process includes separating hydrocarbon vapors from the catalyst feed under gravity and distributing upward flowing hydrocarbon vapors separated from the catalyst feed through nozzle holes in the mushroom-shaped distributor cap.

### CROSS-REFERENCE TO RELATED APPLICATIONS

The subject application claims the benefit of priority to U.S. Provisional Ser. No. 63/374,239 , filed Aug. 31, 2022, the disclosure of which is incorporated herein by reference in its entirety.

### BACKGROUND OF THE INVENTION

### 1. Field of the Invention

The present disclosure relates to downer reactors and more particularly to downer reactors that terminate in a vertical primary separator

### 2. Description of Related Art

Traditional downer reactors terminate in a vertical primary separator that separates the bulk of a catalyst from the vapors. The vapors with entrained catalyst exiting the separator are further separated in a close-coupled cyclone system before they enter the main fractionator.

The separated catalyst falls through the respective diplegs into a reactor/stripper. The vapor residence time in the downers range from 0.5 to 1 second. Since the downflow system is a stacked unit, the height of the downer affects the overall height of the system and thus the capacity and capital expenditure (CAPEX) required. The downer height to diameter ratio is adjusted to minimize the overall height while at the same time reducing the scale-up risk in terms of downer diameter and its effect on the catalyst-feed contacting.

In traditional dual downer systems, light and paraffinic hydrocarbon feedstock with boiling point below 660° F. is processed in a light feed (LF) downer and respective reactor while more crackable feedstock with boiling point greater than 660° F. is processed in a heavy feed (HF) downer and reactor. The processing objective is usually to maximize total olefins produced. The LF being paraffinic, requires much severe operating conditions in terms of longer residence time, higher temperature and higher catalyst-to-oil ratio. The catalyst temperature and catalyst-to-oil ratio are set by the regenerator temperature. The vapor residence time depends on the diameter and height of the downer. As stated, typical vapor residence time for the downer system is between 0.5 to 1 seconds. Increasing the residence time beyond 1 second would require either the diameter increase at constant downer height or height increase at constant downer diameter. Both options have capital cost and performance trade-offs.

The conventional techniques have been considered satisfactory for their intended purpose. However, there is an ever present need for improved downer reactors. This disclosure provides a solution for this need.

### SUMMARY OF THE INVENTION

A downer reactor assembly includes an outer disengager vessel, at least one downer reactor extending vertically from a top end to a lower end within the outer disengager vessel, and a mushroom-shaped distributor end cap positioned at the lower end of the at least one downer reactor.

One or more embodiments include the assembly of any previous paragraph, and wherein the at least one downer reactor can include two downer reactors.

One or more embodiments include the assembly of any previous paragraph, and wherein the mushroom shape distributor end cap can be positioned at the lower end of each of the two downer reactors.

One or more embodiments include the assembly of any previous paragraph, and wherein the mushroom-shaped distributor end cap can include a convex surface facing the top end of the at least one downer reactor.

One or more embodiments include the assembly of any previous paragraph, and wherein the at least one downer reactor can include an inlet proximate to the top end.

One or more embodiments include the assembly of any previous paragraph, and wherein the lower end of the at least one downer reactor can be configured and adapted to be submerged in a catalyst bed.

One or more embodiments include the assembly of any previous paragraph, and wherein the mushroom-shaped distributor end cap can be configured and adapted to be submerged in a catalyst bed.

One or more embodiments include the assembly of any previous paragraph, and wherein the assembly can include a close-coupled cyclone system above the lower end of the at least one downer reactor. One or more embodiments include the assembly of any previous paragraph, and wherein a vapor residence time in the at least one downer reactor ranges from 0.5 to 1 second.

In accordance with another aspect, a process for cracking a hydrocarbon feedstock includes providing a catalyst feed to at least one downer reactor assembly. Discharging the catalyst feed at a lower end of at least one downer reactor underneath a mushroom-shaped distributor cap. The process includes separating hydrocarbon vapors from the catalyst feed under gravity and distributing upward flowing hydrocarbon vapors separated from the catalyst feed through nozzle holes in the mushroom-shaped distributor cap.

One or more embodiments include the process of any previous paragraph, and wherein the mushroom-shaped distributor can include a convex surface facing a top end of the at least one downer reactor.

One or more embodiments include the process of any previous paragraph, and wherein discharging the catalyst feed at the lower end of the at least one downer reactor can include discharging at least a catalyst portion of the catalyst feed into a catalyst bed.

One or more embodiments include the process of any previous paragraph, and wherein the process can include providing additional residence time for the upward flowing vapors after discharging to promote additional conversion for an unreacted portion of a hydrocarbon portion of the catalyst feed discharged from the lower end of the at least one downer reactor.

One or more embodiments include the process of any previous paragraph, and wherein the mushroom-shaped distributor end cap can be configured and adapted to be submerged in a catalyst bed.

One or more embodiments include the process of any previous paragraph, and wherein the process can include discharging upward flowing vapors to a close-coupled cyclone system.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic plan view of a reactor and disengager vessel having a downer reactor assembly in accordance with an embodiment of the present disclosure, showing a mushroom-shaped distributor end cap; and

FIG. 2 is a schematic perspective view of a mushroom-shaped distributor end cap of a downer reactor assembly in accordance with an embodiment of the present disclosure;

### DETAILED DESCRIPTION OF THE PREFERRED EMBODIMENTS

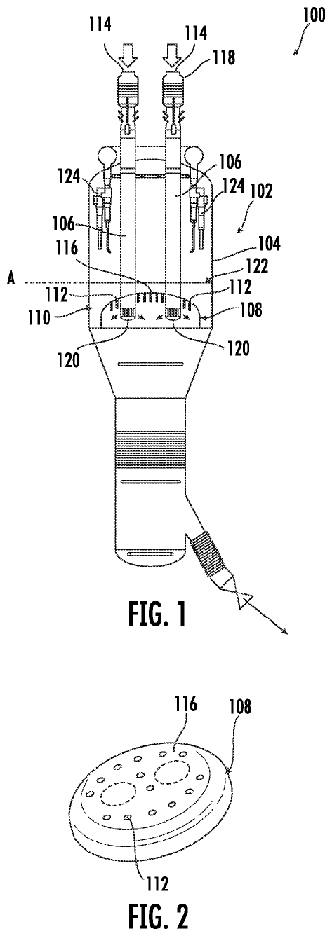

Reference will now be made to the drawings wherein like reference numerals identify similar structural features or aspects of the subject disclosure. For purposes of explanation and illustration, and not limitation, a schematic view of an exemplary embodiment of the downer reactor assembly in accordance with the disclosure is shown in FIG. 1 and is designated generally by reference character 100. Other embodiments of the downer reactor assembly in accordance with the disclosure, or aspects thereof, are shown in FIG. 2 and described throughout the specification. The systems and methods described herein can be used to maximize total olefins produced by increasing the vapor residence time without increasing either the downer diameter or the height.

As shown in FIG. 1, a dual downer reactor assembly 100 includes at least one reactor 102 having a outer disengager vessel 104. The downer reactor assembly 100 includes two downer reactors 106 that terminate in a reactor, e.g. in reactor 102. Reactor 102 can be a light feed (LF) reactor and/or a heavy feed (HF) reactor. The downer reactor assembly 100 can process light and paraffinic hydrocarbon feedstock in a LF downer, e.g. a first of the two downer reactors 106, in combination with a catalyst, while heavier and more crackable hydrocarbon feed stock is processed in a HF downer, e.g. a second of the two downer reactors 106, in combination with a catalyst. In assembly 100, instead of a separator at the bottom of the downer reactors 106, downer reactors 106 discharge under a mushroom distributor end cap 108 located in disengager vessel 104 where the catalyst separates under gravity and the vapors are distributed through nozzles 112 in mushroom distributor 108 into the catalyst bed 110 above it. Residence time in a given downer reactor 106 is around one second. Additional residence time, in the order of minutes, is achieved in a fluidized bed 110, described below, if required.

As shown in FIGS. 1-2, mushroom shape distributor end cap 108 is positioned above lower ends 120 of each of the two downer reactors 106. Mushroom-shaped distributor end cap 108 includes a convex surface 116 facing a top end 118 of downer reactor 106. Downer reactors 106 each include an inlet 114 proximate to top end 118. Catalyst entering inlets 114 is shown schematically by downward pointing arrows. Lower end 120 of each downer reactor 106 is configured and adapted to be submerged in a catalyst bed 110. Mushroom-shaped distributor end cap 108 is also configured and adapted to be submerged in catalyst bed 110. Assembly 100 includes a close-coupled cyclone system 124 above lower end 120 of the downer reactors 106 more proximate top end 118 than lower end 120. A vapor residence time in the downer reactors 106 ranges from 0.5 to 1 second. Additional residence time, in the order of minutes, is achieved in a fluidized catalyst bed 110 below downer reactors 106. If required, the height A of catalyst bed level 122 above the mushroom-shaped distributor is varied to achieve the residence time needed for additional conversion of the unreacted feed exiting downer reactors 106. The vapors together with the stripping steam flow through a cyclone system before entering the main fractionator.

A process for cracking a hydrocarbon feedstock includes providing a catalyst feed to a downer reactor assembly, e.g. a downer reactor assembly 100, as shown schematically by the arrows pointing towards an inlet 114 of downer reactors 106. This catalyst feed is combined with a hydrocarbon feedstock (LF or HF) for cracking the hydrocarbon feedstock (which can be in the form of hydrocarbon vapors). The process includes discharging the catalyst feed at a lower end, e.g. lower end 120, of the downer reactor underneath a mushroom-shaped distributor cap, e.g., mushroom-shaped distributor cap 108. At the lower end 120 it is contemplated that at least a portion of the hydrocarbon feedstock (e.g., in the form of hydrocarbon vapors) is also discharged. The process includes separating the catalyst feed from the hydrocarbon feed under gravity and distributing upward flowing vapors (e.g., hydrocarbon vapors) separated from the catalyst feed through nozzle holes, e.g., nozzle holes 112, in the mushroom-shaped distributor cap. Discharging the catalyst feed at the lower end of the downer reactor includes discharging the catalyst feed into a catalyst bed, e.g., catalyst bed 110. The process includes providing additional residence time for the upward flowing vapors (e.g., hydrocarbon vapors) after discharging to promote additional conversion for an unreacted portion of a hydrocarbon portion of the catalyst feed discharged from the lower end of the at least one downer reactor. The mushroom-shaped distributor end cap is configured and adapted to be submerged in the catalyst bed. In some embodiments, the process includes discharging upward flowing vapors to a two stage cyclone system, e.g. close-coupled cyclone system 124.

Embodiments of the present disclosure provide for increased feed conversion in downer processing of light hydrocarbon feedstocks. Reactor system 100 incorporates dense bed cracking with ability to control dense bed gas residence time and hydrocarbon partial pressure. Embodiments of the present disclosure provide for downer reactors with improved selectivity towards propylene, without an increase in CAPEX and operational expenses (OPEX). Embodiments of the present disclosure provide increased catalyst utilization offsetting partial catalyst bypassing in the downer.

The methods and systems of the present disclosure, as described above and shown in the drawings, provide for systems and methods of downer reactor assembly with superior properties including increased controllability, improved selectivity towards propylene, without an increase in CAPEX and OPEX costs. The systems and methods of the present invention can apply to HS-FCC technology, or the like. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A downer reactor assembly, the assembly including:
an outer disengager vessel;
at least one downer reactor extending vertically from a top end to a lower end within the outer disengager vessel; and
a mushroom-shaped distributor end cap positioned at the lower end of the at least one downer reactor.

2. The assembly as recited in claim 1, wherein the at least one downer reactor includes two downer reactors, wherein the mushroom shape distributor end cap is positioned at the lower end of each of the two downer reactors.

3. The assembly as recited in claim 1, wherein the mushroom-shaped distributor end cap includes a convex surface facing the top end of the at least one downer reactor.

4. The assembly as recited in claim 1, wherein the at least one downer reactor includes an inlet proximate to the top end.

5. The assembly as recited in claim 1, wherein the lower end of the at least one downer reactor is configured and adapted to be submerged in a catalyst bed.

6. The assembly as recited in claim 1, wherein the mushroom-shaped distributor end cap is configured and adapted to be submerged in a catalyst bed.

7. The assembly as recited in claim 1, further comprising a close-coupled cyclone system above the lower end of the at least one downer reactor.

8. The assembly as recited in claim 1, wherein a vapor residence time in the at least one downer reactor ranges from 0.5 to 1 second.

9. A process for cracking a hydrocarbon feedstock, the process comprising:
providing a catalyst feed to at least one downer reactor assembly;
discharging the catalyst feed at a lower end of at least one downer reactor underneath a mushroom-shaped distributor cap;
separating hydrocarbon vapors from the catalyst feed under gravity; and
distributing upward flowing hydrocarbon vapors separated from the catalyst feed through nozzle holes in the mushroom-shaped distributor cap.

10. The process as recited in claim 9, wherein the mushroom-shaped distributor includes a convex surface facing a top end of the at least one downer reactor.

11. The process as recited in claim 9, wherein discharging the catalyst feed at the lower end of the at least one downer reactor includes discharging at least a catalyst portion of the catalyst feed into a catalyst bed.

12. The process as recited in claim 9, providing additional residence time for the upward flowing vapors after discharging to promote additional conversion for an unreacted portion of a hydrocarbon portion of the catalyst feed discharged from the lower end of the at least one downer reactor.

13. The process as recited in claim 9, wherein the mushroom-shaped distributor end cap is configured and adapted to be submerged in a catalyst bed.

14. The process as recited in claim 9, further comprising discharging upward flowing vapors to a two stage cyclone system.
